(19) United States
(12) Patent Application Publication
(10) Pub. No.: US 2005/0023126 A1
(43) Pub. Date: Feb. 3, 2005

(54) Extended distillation system, specially for marine water

(76) Inventor: Gines Sanchez Gomez, Mostoles (Madrid) (ES)

Correspondence Address: Gines SANCHEZ GOMEZ, Calle Cervantes, 1, 7, B, Mostoles, 28932, ES

(21) Appl. No.: 10/925,081

(22) Filed: Aug. 25, 2004

Related U.S. Application Data
(63) Continuation-in-part of application No. 10/374,924, filed on Feb. 24, 2003.

(30) Foreign Application Priority Data
Sep. 10, 2003 (ES) P200302154

(51) Int. Cl. B01D 3/42; C02F 1/04; B01D 3/10

(52) U.S. Cl. 203/11; 203/2; 203/91; 202/205; 202/160; 202/176

(57) ABSTRACT

The vacuum distillation system of application U.S. Pat. No. 10/374,924 which compensates the pressures of the input and output products it is extended by using a common interchange space by the low compression of the liquids and another performances as raising fresh water, using water salt saturated, using atmospheric water vapor or using facility for condensation.

### CROSS-REFERENCE TO RELATED APPLICATIONS

The present invention is based on the Spanish application of patent no.P200302154 dated Sep. 10, 2003, that is priority. Also is an extended application regarding the U.S. Pat. No. 10/374,924 patent application. Following patents are related with the present invention:
U.S. Pat. No. 6,494,995. A floating solar cell, being created a partial vacuum in the solar cell.
U.S. Pat. No. 6,391,162. A desalination system utilizing solar energy provided with a solar heat collector, a heat exchanger, a condenser and a raw water tank.

### BACKGROUND OF THE INVENTION

The previous U.S. Pat. No. 10/374,924 application for patent is about a vacuum distillation system which compensates the pressures of the input and output products, doing at the same time the input and the output of the products through a turbine and a pump with a common shaft, allowing very low work pressures.

### BRIEF SUMMARY OF THE INVENTION

Another way for compensating the input and output pressures is by using a common interchange space (interchange tank) by the low compression of the liquids, according the following:
the interchange tank is at the system pressure (low pressure),
the interchange tank is fullfilled with distilled water from a condensation tank,
the interchange tank is isolated from the rest of the system by valves, being opened to the atmosphere by another valve,
the distilled water is easily removed from the interchange tank,
the interchange tank is fullfilled with sea water, being isolated from the atmosphere and opened to the system,
the evaporation tank is fed with the sea water from the interchange tank.
   But the using of the interchange tank is only possible if the pollution of the residues into the interchange tank is acceptable.

Another performances are added:
the system can be fed with water salt saturated o near the saturation point, speeding the evaporation by the heat crystallization of the salt,
also may be fed with atmospheric water vapor using a deliquescence product, as calcium chloride or aluminium chloride (61) by condensing the atmospheric water vapor until creating a liquid,
facility for condensation of the evaporated water vapor by atomizing fresh water, increasing the condensation surface.

Naturally the system is suitable to be applied for any product. Especially the system may be used to purify polluted waters if the small pollution of the interchange tank is allowed.

### BRIEF DESCRIPTION OF THE FIGURES

FIG. 1. General distillation system.

FIG. 2. Distillation system control.

FIG. 3. The distillation system to obtain fresh water and salt from the sea water.

FIG. 4. The distillation system using an interchange tank.

FIG. 5. Control of the distillation system with the interchange tank.

FIG. 6. Feeding the distillation system with salt saturated water.

FIG. 7. Feeding the distillation system with atmospheric water vapor.

FIG. 8. The distillation system to obtain fresh water and salt from the sea water by using the vacuum suction forces of the system and the crystallization heat of the salt.

FIG. 9. The distillation system for obtaining fresh water and salt from the sea water by raising the fresh water, by using the interchange tank.

FIG. 10. The distillation system with raised evaporation zone being cooled by sea water.

FIG. 11. Cooling the condensation zone by using atomized water.

### DETAILED DESCRIPTION OF THE INVENTION

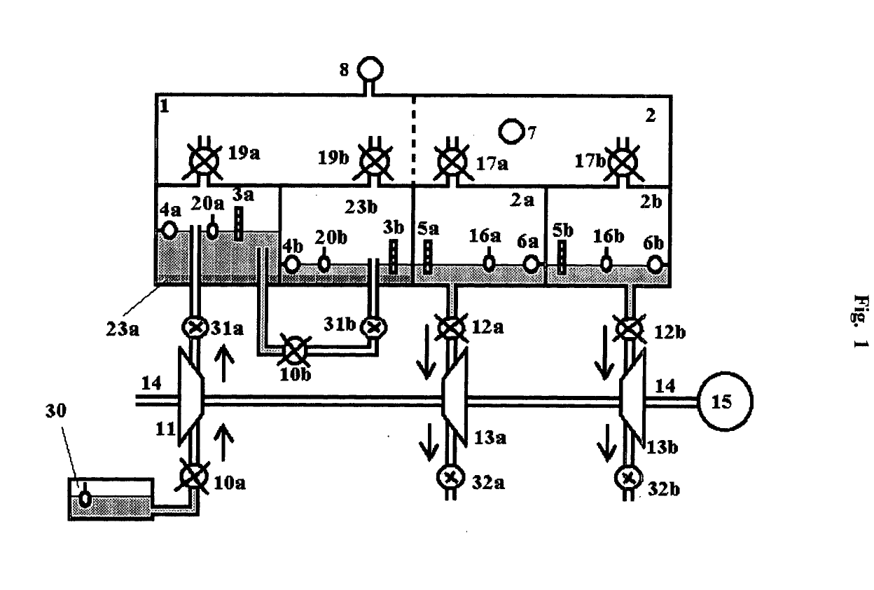

FIG. 1 illustrates a very general distillation system with a evaporation zone 1 and a condensation zone 2. The zone 1 having one or several subzones of solid or high viscosity residues 23a, 23b, while the zone 2 having one or several condensation subzones 2a, 2b. Each residue or condensation subzone provided with a thermometer 3a, 3b, 5a, 5b, a densimeter 20a, 20b, 16a, 16b, a capacity sensor 4a, 4b, 6a, 6b and an isolation valve 19a, 19b, 17a, 17b, while each residue subzone is provided with an input valve 10a, 10b and an input fluxemeter 31a, 31b, while each condensation subzone is provided with an outlet valve 12a, 12b, an outlet fluxemeter 32a, 32b and an extraction pump 13a, 13b. The product from outside the system to the first residue subzone 23a enters through an input turbine 11, being measured the density of the product by an input densimeter 30. The product enters to the second and subsequent residue subzones from the preceding residue subzone. The whole evaporation system has a manometer 7, and a vacuum pump 8.

The turbine and all the extraction pumps having a common shaft 14 and a motor 15 (by example electric). The control of the turbine and the extraction pumps is through the motor 15.

The relative volume between the input turbine and each extraction pump must be the same that its connected products.

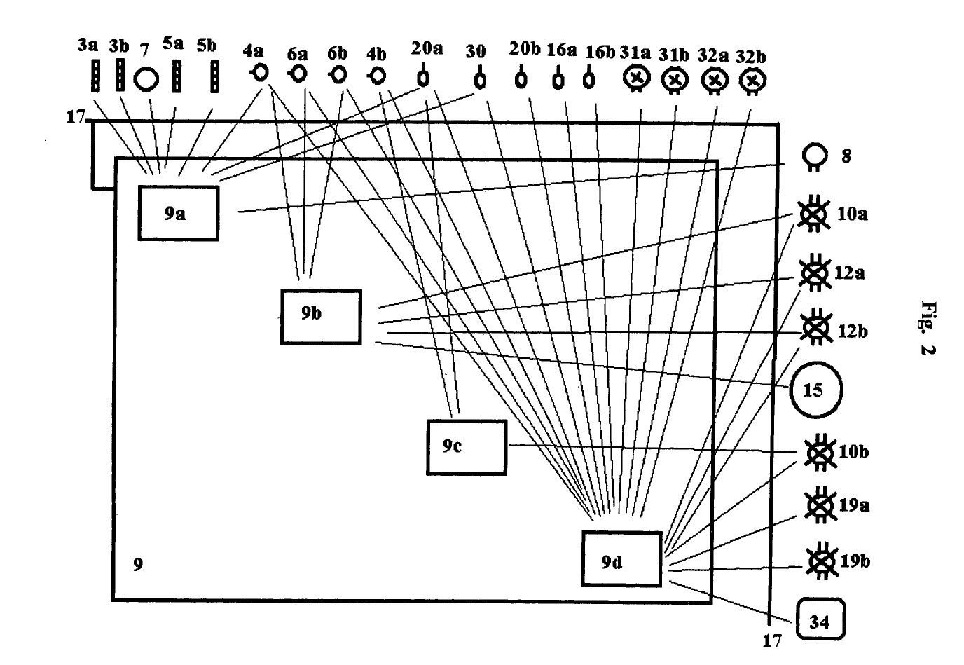

FIG. 2. Distillation system control. The thermometers, the capacity sensors, fluxemeters, densimeters and manometer are provided with digitalizers and they are connected with a control computer 9 through a local network 17. Also the valves, the motor and the vacuum pump are provided with control devices, said control devices being connected with the control computer 9 through the local network 17.

The control computer 9 by mean of a pressure-temperature-density function 9a activates the vacuum pump 8 until which the boiling temperature of the product at the internal pressure from the manometer of the system 7 is intermediate between the temperatures from the thermometers of the residue subzones 3a, 3b and from the thermometers of the condensation subzones 5a, 5b. The pressure-temperature-density function gets the value of the initial density of the product from the input densimeter 30 (when no product to distillate into the first residue subzone) and more forward from the first residue subzone densimeter 20a.

The control computer by mean of a feeding-recovering function 9b activates the motor 15 and the input and outlet valves 10a, 12a, 12b when the value from the capacity sensor of the first residue subzone 4a is under a prefixed value and the values from the capacity sensors of the condensation subzones 6a, 6b are over another prefixed value, until which the value of said capacity sensors return the equilibrium values.

The control computer by mean of a residue transfer function 9c activates the input valves 10b of the second and subsequent residue subzones when the value from the densimeter of the precedent residue subzone 20a is over a prefixed value, if the value from the capacity sensor of the second or subsequent residue subzones 4b are not over another prefixed value.

The control computer by mean of a residue calculation function 9d determines the values of the residues into each residue subzone, having in account the values of the densimeters, fluxemeters, capacity sensors and the mass conservation law. When the residues of one residue subzone is over a prefixed value, said residue calculation function closes the input valve until which all the product of said residue subzone is evaporated, closing the outlet and isolation valves of said residue subzone, informing the system operator through a screen or alarm 34 to recover the residues.

The control of the isolation valves of the condensation subzones 17a, 17b is not part of this invention, being part of each particular distillation system, being well know from the state of the art.

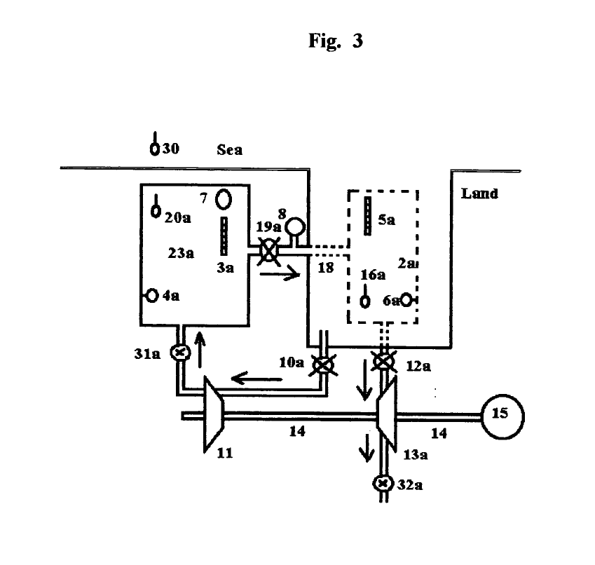

FIG. 3 shows a sea water distillation. The evaporation zone, which is coincident with the first residue subzone, is a evaporation tank placed at the sun 23a and fed by the sea water, while the condensation zone is a submerged condensation tank 2a, its walls being thermally conductors. The capacity sensors are buoys

The capacity of the turbine 11 and the extraction pump 13 are substantially the same.

A vapor conduit 18 links the evaporation tank 23a and the condensation tank 2a, being the vacuum pump 8 on said conduit, and having said conduit an isolation valve 19a. Said vapor valve 19 is useful when the evaporation tank is emptied, because by closing said vapor valve the vacuum of the condensation tank is preserved.

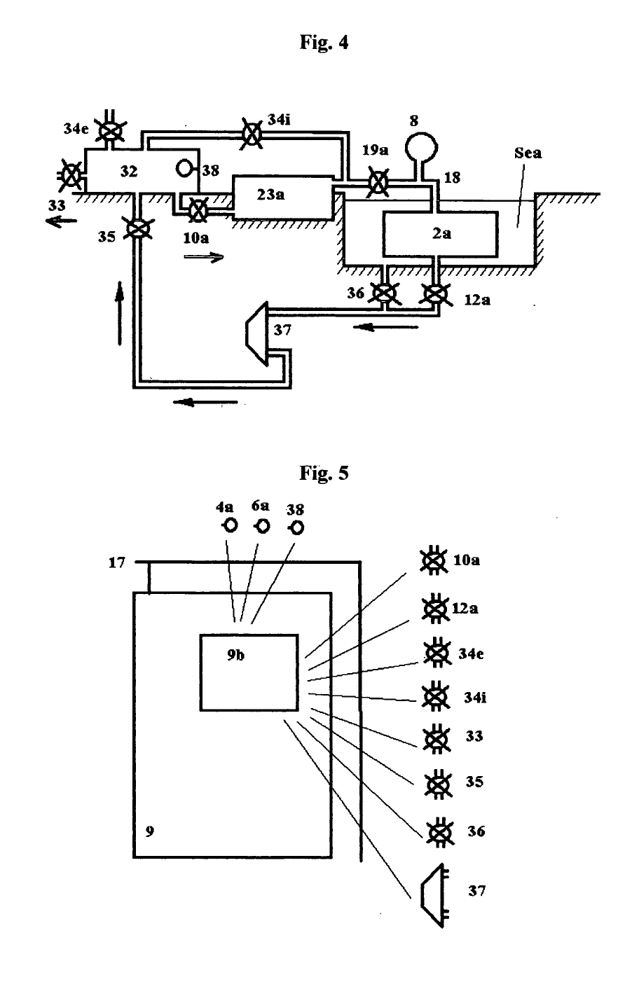

FIG. 4. The distillation system using an interchange tank has the usual evaporation tank 23a and condensation tanks 2a, with they inputs 10a, outlets 12a and isolation valves 19a, vacuum pump 8, vapor conduit 18, and sensors as fluxemeters, thermometers, densimeters, . . .

Especially the distillation system has an interchange tank 32 fed through the valve 35 and the pump 37 alternatively of fresh water when the valve 12a is opened and the valve 36 is closed, or sea water in the opposite case. Said interchange tank is emptied:
if it contains fresh water through the valve 33, to outside,
if it contains sea water through the valve 10a, into the evaporation tank.

To fill the interchange tank 32 with sea water, the equalizing valve of atmospheric pressure 34e is opened and the equalizing valve of system pressure 34i is closed, while to fill the interchange tank with fresh water the valve 34i is opened and the valve 34e is closed. Naturally in both cases the outlet valves 33, 10a and the input valve of the interchange tank 32 are closed.

To empty the interchange tank of fresh water through the valve 33, the valve 34i is closed and the valve 34e is opened, while to empty the interchange tank of sea water is the opposite. Obviously in both cases the valve 35 are closed.

The interchange tank is always full filled or full emptied, by this a capacity sensor 38 is provided.

The liquid capacity of the condensation tank 2a must be upper the capacity of the interchange tank 32, for full filling the interchange tank from the condensation tank.

FIG. 5. The control of the distillation system with interchange tank is performed through the computer function of feeding-recovering 9b of said figure. Initially, the capacity sensors of the evaporation, condensation and interchange tanks 4a, 6a, 38 must be started and all the valves of the interchange tank must be closed 34e, 34i, 33, 35, 10a.

The performances of the computer function of feeding-recovering 9b are:
if the reading of the capacity sensor of the condensation tank is under the capacity of the interchange tank and the reading of the capacity sensor of the interchange tank 38 is zero, the valves 34e 36 y 35 are opened and the valves 12a and 34i are closed, activating the pump 37 until the maximal reading of the sensor 38,
   then the valves 34e, 36 y 35 are opened and the valve 34i is closed,
   if the reading of the capacity sensor of the evaporation tank is low, the valve 10a is opened until which said capacity sensor of the evaporation tank reaches its top,
   if the reading of the capacity sensor of the condensation tank is under the capacity of the interchange tank and the reading of the capacity sensor of the interchange tank 38 is zero, the valve 10a is closed and the valves 12a and 35 are opened, activating the pump 37 until the maximal reading of the sensor 38,
   then the valves 12a, 35 and 34i are closed, and the valves 34e and 33 are opened until which the reading of the sensor 38 is zero.

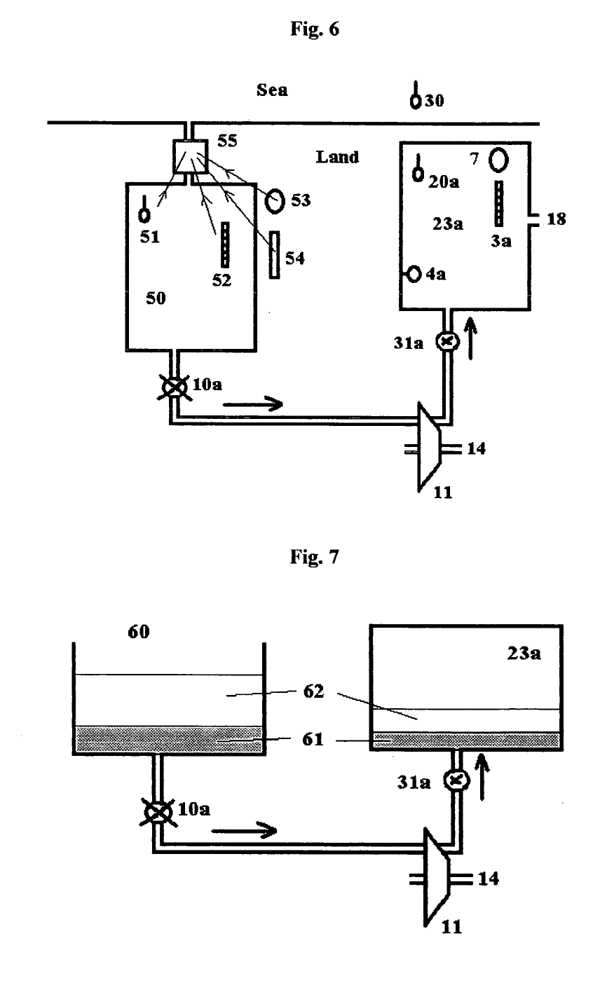

FIG. 6. Feeding the distillation system with salt saturated water. When the liquid to distillate is sea water, the evaporation tank 23a can be fed from a preevaporation reservoir 50 with water salt saturated o near the saturation point. The saturation is reached by evaporating water by the sun heat. When said saturation point is reached, the preevaporation reservoir is fed from the sea, avoiding the salt crystallization (on the preevaporation reservoir).

The salt concentration of the preevaporation reservoir, the environment temperature, atmospheric pression and humidity is respectively measured by a preevaporation densimeter 51, thermometer 52, manometer 53 and hygrometer 54. Said sensors control a feeding device for preevaporation 55 which is started when the saturation density is reached, being stopped when the density is under a prefixed value.

The previous is for lowering the size of the vacuum space, because the evaporation is speeded by the heat crystallization of the salt.

The feeding device for preevaporation may be a valve or a pump according the sea level regarding the preevaporation reservoir.

The preevaporation resevoir can be a marine zone as a small bay provided with a dock for closing said marine zone.

FIG. 7. Feeding the distillation system with atmospheric water vapor. An open precipitation reservoir 60 is provided, said precipitation reservoir having a deliquescent product, as calcium chloride or aluminium chloride 61. Said deliquescent product condensates the atmospheric water vapor until create a liquid 62. This liquid 62 can be distilled by connecting the precipitation reservoir with the evaporation tank 23a.

For avoiding the transport of the deliquescent product from the condensation tank 23a to the precipitation reservoir 60, the last device can be configurated similarly the condensation tank, both having a transparent mobile cover. So, both devices would be interchanged.

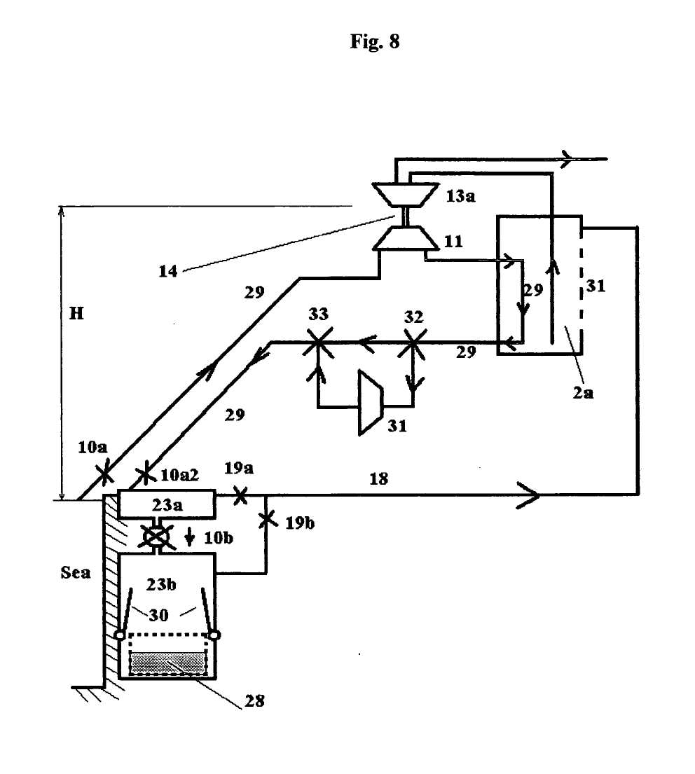

FIG. 8. The distillation system to obtain fresh water and salt from the sea water by using the vacuum suction forces of the system and the crystallization heat of the salt. This figure is very similar that FIG. 3, with the following differences:
the evaporation tank 23a has not residues, being linked to a second evaporation tank 23b with a container of residues 28 and isolation hatches 30,
the turbine 11 is raised H regarding the sea level,
the sea water feeds the evaporation tank through a conduit 29 which raises until the turbine 11,
the conduit 29 is provided with a primed pump 31 and control valves 32 and 33 of said primed pump, supposing that the conduit 29 between the two valves 32 and 33 is fullfilled of water,
the condensation tank 2a is cooled by the water of the conduit 29 and by an heat interchanger 31,
the water from the first evaporation tank 23a goes to the second evaporation tank 23b when the reading of the densimeter of said first evaporation tank is near to the saturation water of salt, by this, no residue is in the first evaporation tank,
when the container 28 is filled with salt, the isolation hatches 30 are closed, being the container 28 recovered, emptied and returned filled with water salt saturated to maintain the vacuum of the system.

By previous:
the sea water would be raised by the suction of the vacuum of the system the maximal height
   H=(1 at.−system pressure) * 10.33 m./(sea water density)

being 1 at.=10.33 m. of fresh water
but H would be
   H>(1 at.−system pressure)×10.33 m./(sea water density)

if the current of water into the conduit 29 is started by the primed pump 31,
said height H of the sea water implies that also the turbine 11 and the pump 13a can be raised, y by this, the evaporation tank 2a, y by this, the fresh water of said evaporation tank,
the fresh water can be raised an additional height providing the common shaft 14 of the turbine 11 and the pump 13a in a vertical sense,
the sea water of the conduit 29 is warmed in part by passing the condensation tank,
the water salt saturated of the second evaporation tank can be evaporated with a low external heat,
the previous permits the functioning of the system on the night with a low external heat.

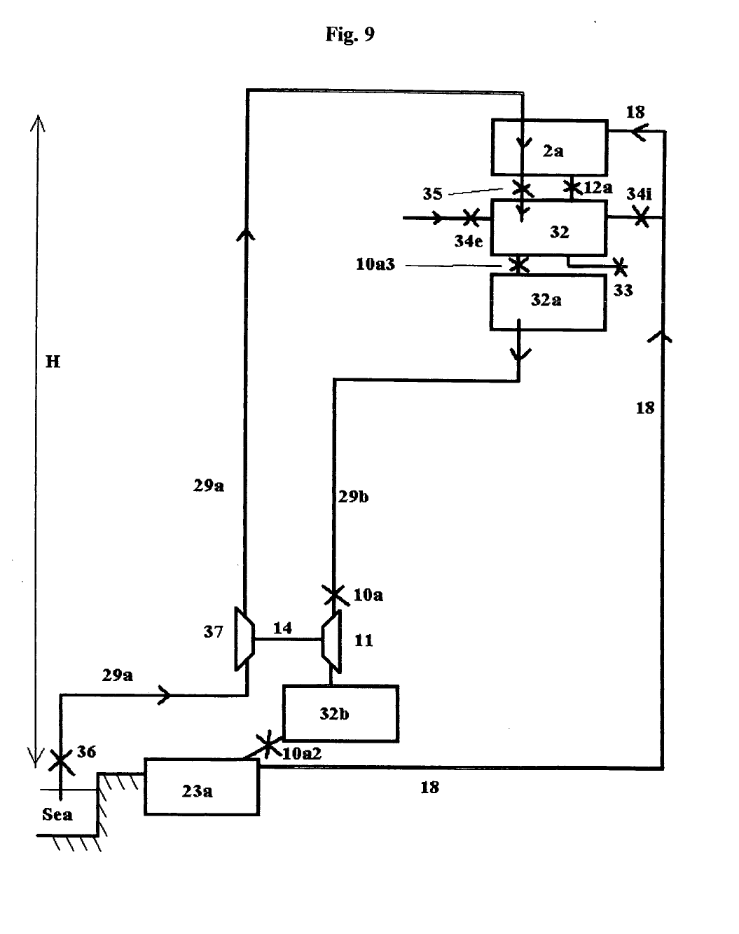

FIG. 9. The distillation system for obtaining fresh water and salt from the sea water by raising the fresh water, using an interchange tank. This figure contains devices of the FIGS. 4 and 8 with the following additions:
the interchange tank 32 is on high, near the condensation tank a2, also on high,
the interchange tank 32 is not connected with the evaporation tank through the valve 10a being connected through waiting tanks 32a, 32b, through regulations valves 10a1, 10a3, and the turbine 11 which is linked with the feeding pump of the interchange tank 37 through the common shaft 14,
the waiting tanks 32a, 32b are at the system pressure,
the sea water from the interchange tank 32 is stored into the first waiting tank 32a for storing its gravitational energy,
when the interchange tank 32 is fed by the pump 37, the gravitational energy of the sea water of the first waiting tank 32a helps the pump 37 through the turbine 11,
the sea water from the first waiting tank 32a is stored into the second waiting tank 32b, for feeding the evaporation tank in time 23a.

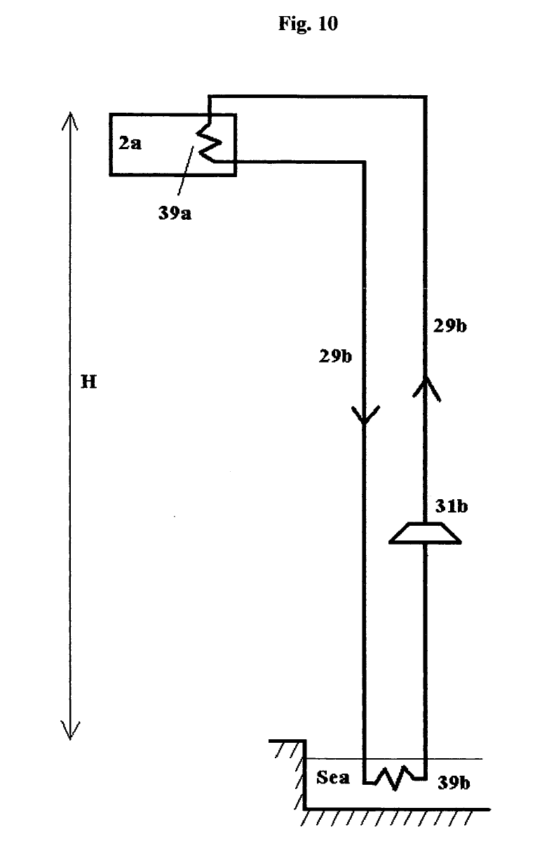

FIG. 10. The distillation system with raised evaporation zone being cooled by sea water. The condensation tank 2a can be cooled through a cooling closed circuit comprising a conduit 29b, a dragging pump 31b, an first heat interchanger into the condensation zone 39a and a second heat interchanger into the sea 39b. Only the a dragging pump 31b expends energy.

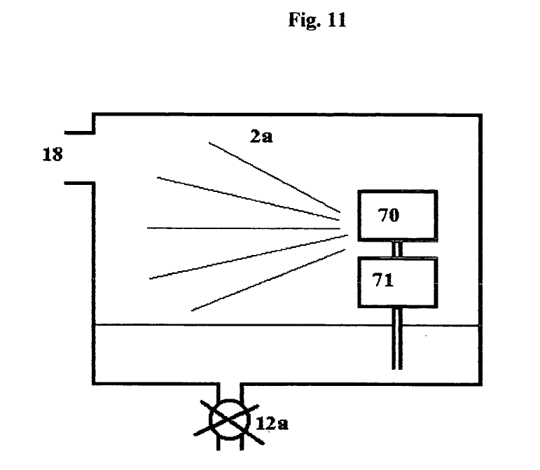

FIG. 11. Cooling the condensation zone by using atomized water. For condensation facility into the condensation tank 2a a fresh water atomizer is arranged 70 into the condensation tank 2a. Eventually said atomizer can be fed through an cooler 71. The fresh water is from the condensation tank. By previous, the condensation surface is increased at the price of a small amount of energy.

1. A vacuum distillation method for a liquid to distillate with dissolved liquids and solids for low difference of temperature between an evaporation zone and a condensation zone of a distillation system, comprising
the liquid to distillate and a distilled liquid are entered/removed to/from the distillation system by using alternatively a common interchange zone, said common interchange zone alternatively at an external pressure/an internal work pressure, by making use of the low compression of liquids,
recovering a precipitated dissolved solid from the distillation system when its volume is over a prefixed value, maintaining the work pressure of the distillation system.

2. The vacuum distillation method of claim 1 when the dissolved solids is a salt as sodium chloride having a crystallization heat comprising
using as an heat source the crystallization heat of the salts at least in part,
prevaporizing sea water for obtaining saturated salt water and feeding the distillation system with said saturated salt water.

3. The vacuum distillation method of claim 1, comprising
obtaining the liquid to distillate by condensing atmospheric water vapor on a deliquescent product as calcium chloride or aluminium chloride on a deliquescent zone,
interchanging the deliquescent zone and the condensation zone.

4. The vacuum distillation method of claim 1, comprising
raising the distilled liquids by using vacuum forces of the distillation system,
cooling the raised distilled liquid through convection.

5. The vacuum distillation method of claim 1, comprising
raising the distilled liquids by using vacuum forces of the distillation system,
cooling the raised distilled liquid by sea water through a closed cooling circuit.

6. A vacuum distillation system for a liquid to distillate for low difference of temperature between an evaporation zone and a condensation zone which can hold one o several condensation subzones, each condensation subzones having a capacity sensor, a thermometer and an outlet valve, being controlled by a control computer through a local network comprising:
one o several residue subzones in the evaporation zone,
each residue subzone having a thermometer, a densimeter, a capacity sensor, an isolation valve, an input valve and an input fluxemeter,
each condensation zone having a densimeter and a fluxemeter,
the liquid to distillate enters the system to the first residue subzone, being previously measured its density by an input densimeter,
the liquid to distillate enters the second and subsequent residue subzone from the proceding residue subzone,
the thermometer, densimeter, fluxemeter, manometer and capacity sensors being digital or provided with digitalizer, being connected to the control computer through the local network,
the isolation, input and outlet valves being computer controlled or provided with control devices, being connected to the control computer through the local network,
a computer function of pressure-temperature-density to control the vacuum pump according the values of the thermometers, the manometers and the density of the product to distillate,
a computer function of residue transfer to transport the product from a initial residue subzone to the subsequent residue subzone according the values of the densimeter of the initial residue subzone and the capacity sensor of the subsequent residue subzone,
a computer function of residue calculation to control the residues recovering according the values of the densimeter, capacity sensor and fluxemeter, maintaining the vacuum of the rest of the system,
means for compensating pressure differences as an interchange tank or a set of turbine-extraction pump-common shaft.

7. The vacuum distillation system of claim 6 when the pressure differences are compensated by means of the set of turbine-extraction pump-common shaft, having each condensation subzone an extraction pump and an outlet valve, a turbine for entering the liquid to distillate through an input valve and the turbine and the extraction pumps having a common shaft and motor, comprising a computer function of feeding-recovering for controlling the input valves, the outlet valves and the motor, according the value of the capacity sensors.

8. The vacuum distillation system of claim 6 when the pressure differences are compensated by means of the set of turbine-extraction pump-common shaft, characterized in that the condensation zone is on high being the common shaft between the turbine and the extraction pump vertically arranged.

9. The vacuum distillation system of claim 6 when the pressure differences are compensated by means of the interchange tank, comprising
a equalizing valve of atmospheric pressure
a equalizing valve of system pressure
a capacity sensor of the interchange tank,
a computer function of feeding-recovering for controlling the movements of the liquids between the interchange tank and into and outside the system, according measures of the capacity sensors of the interchange tank, the first subzone of residues and the condensation zone.

10. The vacuum distillation system of claim 6 when the pressure differences are compensated by means of the interchange tank, characterized in having the interchange tank on high and comprising
a first waiting tank near the interchange tank,
a second waiting tank near the evaporation zone,
a turbine between the first and second waiting tanks,
the interchange tanks at the work pressure,
said turbine connected to a fed pump of the evaporation zone.

11. The vacuum distillation system of claim 6 characterized in that the condensation zone is on high being cooled by convection, while the liquid to distillate is moved initially through a primed pump.

12. The vacuum distillation system of claim 6 characterized in that the condensation zone is on high being cooled by sea water through a cooling closed circuit having a first heat interchanger into the condensation zone and a second heat interchanger into the sea water.

13. The vacuum distillation system of claim 6 when the liquid to distillate is sea water, being the evaporation zone an evaporation tank having a transparent cover and being the condensation zone a condensation tank, comprising a second evaporation tank filled with a water salt saturated from the evaporation tank at least warming in part the liquid to distillate by crystallization of the water salt saturated.

14. The vacuum distillation system of claim 6, each residue subzone comprising a mobile container to remove residue, and also isolation hatches.

15. The vacuum distillation system of claim 6 when the liquid to distillate is sea water, being the evaporation zone an evaporation tank having a transparent cover comprising a preevaporation reservoir for feeding the evaporation tank with salt saturated water, specially the preevaporation reservoir being a marine zone as a small bay closed by a dock, said preevaporation reservoir being opened and having a thermometer, a densimeter, a manometer and an hygrometer for controlling a feeding device for preevaporation, being the feeding device a valve or a pump according than sea level is over o under the preevaporation reservoir.

16. The vacuum distillation system of claim 6 comprising a precipitation reservoir having a deliquescent product for picking up water vapor from the atmosphere, said precipitation reservoir being open and feeding the evaporation zone, specially the precipitation reservoir having a structure similar than the first evaporation subzone both with a mobile transparent cover and interchanging functioning.

17. The vacuum distillation system of claim 6 when the liquid to distillate is sea water, being the evaporation zone an evaporation tank and being the condensation zone a condensation tank, the condensation tank comprising a fresh water atomizer, and eventually said atomizer being fed through an cooler, the fresh water is from the condensation tank.

18. Using the system of the invention for purify polluted waters.
